(19) United States
(12) Patent Application Publication
(10) Pub. No.: US 2011/0280147 A1
(43) Pub. Date: Nov. 17, 2011

(54) Front-End Module and Method for Testing a Front-End Module

(75) Inventors: Pasi Tikka, Muenchen (DE); Andreas Przadka, Muenchen (DE); Joerg Schuler, Singapore (SG)

(73) Assignee: EPCOS AG, Muenchen (DE)

(21) Appl. No.: 13/154,096

(22) Filed: Jun. 6, 2011

Related U.S. Application Data
(63) Continuation of application No. PCT/EP2009/065007, filed on Nov. 11, 2009.

(30) Foreign Application Priority Data
Dec. 10, 2008 (DE) 10 2008 061 474.2

(51) Int. Cl. H04W 24/00; H04B 7/00

(52) U.S. Cl. 370/252; 455/115.1; 370/277; 455/115.2

(57) ABSTRACT

For simpler and more rapid testing of a front-end module, additional linked operating states are provided in the switch and/or its decoder and allow a plurality of paths to be enabled in parallel, in order in this way to test these paths with a smaller number of test routines in a test set, in particular a network analyzer.

This application is a continuation of co-pending International Application No. PCT/EP2009/065007, filed Nov. 11, 2009, which designated the United States and was not published in English, and which claims priority to German Application No. 10 2008 061 474.2, filed Dec. 10, 2008, both of which applications are incorporated herein by reference.

### TECHNICAL FIELD

The invention relates to a front-end module by means of which a simplified test method can be carried out, and to a method for testing the front-end module.

### BACKGROUND

Front-end modules are used in terminals for mobile wireless communication, and in particular in cellular telephones. They represent the interface between the RF electronics, in particular the RF transceiver and the antenna. They comprise signal paths for the operating modes to be controlled by the front-end module, in particular for transmission and reception modes associated with different transmission and reception bands, in different mobile radio systems. In addition, a front-end module contains switches, in order to switch between the various operating modes.

By way of example, modern front-end modules can control more than ten different operating states, which are associated with corresponding transmission and reception modes in different mobile radio systems, using different mobile radio standards and other wireless radio and communication systems, as well. Modern front-end modules correspondingly have a complex design. However, the effort required for testing completed front-end modules after production also rises with the complexity.

In conventional test methods for front-end modules, their inputs and outputs are connected to corresponding inputs and outputs of, for example, a network analyzer. Test routines are then carried out in the various operating states of the front-end module, with test signals being applied to the input, and with the corresponding output signals being determined at the output. A test such as this results in determination of whether the front-end module does or does not comply with the stipulated specifications for mobile radio and communication systems, in all the operating states.

In this case, the operating states are tested in series, as a result of which the test time required for this purpose also increases greatly with the number of possible operating states.

By way of example, FIG. 1 shows the circuit diagram of a front-end module schematically on the basis of a circuit diagram. The front-end module FEM may control four GSM and three WCDMA mobile radio standards. It is split into two sections, which are associated with a low-band range (500 to about 1000 MHz) and a high band range (1800 to 2100 MHz). Each section has a transmission input which is connected to a power amplifier PA.

A first switch S1 is arranged directly behind each transmission input and connects the transmission input to one of the signal paths. Either a duplexer DU or a transmission filter (HBTX, LBTX) is arranged in each of the signal paths. Each section has an antenna connection for its own antenna A1, A2. A second switch S2 connects the antenna connection to a duplexer DU or to a transmission filter HBTX, LBTX.

Received signal paths, in each of which a reception filter FR3 to FR6 is arranged, are likewise connected to the second switch S2, S2′. The reception filters FR3 to FR5 and the reception filter elements of the duplexers DU are connected to the reception outputs RX1 to RX7.

Each of the duplexers DU1, DU2, DU7 can control one WCDMA band in the transmission and reception modes, and each has a transmission filter element and a reception filter element, which are connected to one another.

In addition, each section is designed for operation in in each case two GSM mobile radio systems. For this purpose, each section has a common transmission filter HBTX for the high band range and LBTX for the low-band range, which are designed as low-pass filters for all the GSM transmission frequencies in the respective range, or the respective section. Two reception filters FR3 and FR4 are used for the GSM mobile radio systems in the high band range, while the reception filters FR5 and FR6 are designed and provided for GSM received signal in the low-band range. The respective antenna connection can be selectively connected via the second switch S2, S2′ to one of the duplexers, to the common transmission filter or to one of the reception filters.

FIG. 2 uses an associated mode table to show the nine operating states which can be selected by appropriate switch positions of the switches S1 and S2 in the front-end module FEM. The operating states 1 to 4 are each associated with the low-band section, and the operating states 5 to 9 are in contrast associated with the high band section. The operating states 1 to 9 are associated, in a rising numerical sequence, with a GSM 850 reception band, a GSM 900 reception band, a duplex mode in the WCDMA 900 system, the GSM low-band transmission band, a WCDMA 2100 band, a WCDMA 1900 band, a GSM 1800 reception band, a GSM 1900 reception band and a common GSM high band transmission band.

In a test method for a front-end module such as this at the end of the production process, it is necessary to carry out nine test routines sequentially, which must be carried out sequentially by appropriately sequentially switching the front-end module to the nine operating states, and this involves a large amount of time. First and second switches are designed such that they can individually control all of these nine operating states.

FIG. 3 schematically illustrates how a front-end module FEM can be connected, for example, to a network analyzer NA for testing. For this purpose, a first connection AT1 of the network analyzer is selectively connected by means of a first test switch TS1 to one of the two transmission inputs, and to the first switch located behind it. A second test switch TS2 selectively connects the antenna connection for the first antenna, and the further antenna connection for the second antenna, to the second connection AT2 of the network analyzer NA.

### SUMMARY OF THE INVENTION

In one aspect, embodiments of the present invention specify a front-end module that is designed to allow a simplified and faster test mode for the various transmission and received signal paths.

Embodiments of the invention propose that at least one linked operating state be provided in the front-end module, in addition to the normal individual operating states that are already known, which linked operating state can be used for a simplified test mode for the front-end module. In particular, the linked operating state comprises parallel enabling of a plurality of paths, which are used, for example, for transmission signals, through the front-end module. In further linked operating states, a plurality of received signal paths can be enabled in parallel. It is also possible to enable a signal path which is used for transmission signals and a received signal path at the same time in one linked operating state.

A signal path and/or a received signal path are/is enabled by appropriate settings of the first and second switch in a front-end module whose normal operating modes correspond, for example, to those of the known front-end module which is illustrated in FIG. 1. SPnT (Single Pole n Through) are generally used in known front-end modules and selectively and alternatively, connect one switch input (single pole) to in each case only one of the n different outputs. Now, however, a switch which can connect one connection to a plurality of outputs at the same time, in order to switch the front-end module to a linked operating state, is proposed and required for the present front-end module. Since these linked operating states are additional operating states, this makes it possible to increase the number of operating states, which may be higher than the number of different operating modes during normal operation. An operating mode during normal operation is distinguished by the selection of a frequency band and possibly by association with a transmission or reception mode. A given mobile radio system to a given Standard generally has two operating states, specifically a transmission mode in one transmission band and a reception mode in one reception band. A front-end module which is designed for m mobile radio systems may have up to 2 m normal operating states, where m is an integer greater than unity.

The proposed front-end module for a wireless communication system is designed for operation in a plurality of frequency bands. It has a transmission input for transmission signals and an antenna connection. There are at least two signal paths which are each associated with one frequency band and each connect one transmission input to one antenna connection. At least one first switch is provided which connects the transmission input selectively to a respective one of the signal paths for a normal operating state. The front-end module likewise has a set of control lines for switching the first switch to different operating states, which comprise operating states for normal operation and for the test mode. The number of operating states required for the test mode when using a front-end module according to an embodiment of the invention is less than when using a known front-end module, as a result of which the effort for testing the front-end module is reduced because of the reduced number of operating states to be tested.

Furthermore, the front-end module may have a second switch, which selectively connects the antenna connection to one individual signal path of the signal paths respectively for normal operation. In addition, the second switch also has at least one linked operating state for a test mode, in which a common connection is provided for a plurality of signal paths to the antenna connection.

While a linked operating state opens at least two outputs and inputs on one side of a switch, a front-end module may also have combined operating states, which consist of a combination of linked operating states in the first and second switches. In this case, it is possible to control first and second switches at the same time by means of a common set of control lines.

In this case, it may be advantageous to provide first and second switches in the form of a common switching element and, in particular, for them to be in the form of a common semiconductor component.

Therefore, at least one or more linked or combined operating states, in which a plurality of signal paths are enabled in parallel, can also be provided in the proposed front-end module, in addition to the normal operating states, that is to say in addition to the operating states which are designed for normal operation.

A total of two transmission inputs and in particular two antennas with respective antenna connections can be provided for front-end modules which are designed both for the low-band section and for the high band section. In order to switch the additional signal paths, this further transmission input is connected to a further first switch, and the further antenna connection is connected to a further second switch, via which switches individual signal paths can be enabled for normal operation, and a plurality of paths can be enabled in parallel, for linked operating states, and in particular for combined operating states.

The front-end module also comprises received signal paths which connect one of the antenna connections to a reception output via a second switch. Normal operating states can be switched via first and second switches for pure reception operation in a received signal path which is designed for a mobile radio system. In addition, operating states which are linked via first and second switches can be selected, in which one received signal path is enabled, linked to or combined with a further received signal path and a signal path designed for transmission signals.

A sufficient number of linked operating states can be provided to test all the signal paths for transmission signals and received signal paths. However, it is also possible to combine linked operating states and normal operating states in order to test a front-end module. These states can then be tested successively by means of a test routine. However, in this case, the number of tested operating states is always less than the number of possible normal operating states, as a result of which a simplified test mode is always possible using the front-end module according to an embodiment of the invention.

The front-end module can be designed for different mobile radio standards, such that the signal paths and received signal paths can be associated, for example, in GSM systems and WCDMA systems. In general, for a GSM system, one signal path for transmission signals is provided between the transmission input and the antenna connection, and a received signal path which is separate from this and connects the antenna connection to a reception output. A respective transmission filter or reception filter is provided in both paths.

Simultaneous transmission and reception are possible in WCDMA systems, with corresponding signals being separated via a duplexer. In the operating state for normal WCDMA operation, the duplexer is connected to one of the antenna connections via a second switch. At the same time, a transmission signal path is enabled by an appropriate switch position of the first switch, and the transmission filter element of the duplexer. Only a combination of switch positions in the first and second switches is therefore required for transmission and reception operation for a WCDMA system. In contrast, in a GSM system, the appropriate path must in each case be selected for normal operation in the first and second switches, and the antenna connection is connected to the appropriate received signal output, or the signal path for transmission signals is connected to the transmission signal input and the second switch or antenna connection.

First and second switches for selection of the desired operating states, can be implemented, for example, in a gallium-arsenide semiconductor body and, in particular, may be in the form of an HBT (hetero-bipolar transistor). However, other switches are also possible, in particular pin diodes on silicon or some other semiconductor material, as well as switches which are not based on semiconductor technology but are in the form of mechanical or electromechanical switches and, in particular, MEMS switches. It is advantageous for it to be possible to switch the switches to the appropriate operating states in a simple manner via the control lines.

In addition to joint operation of first and second switches by means of a common set of control lines or by means of an ingenious control signal sequence via these control lines, it is also possible to operate both switches individually and separately from one another, although in this case they are operated such that appropriately linked, common and combined operating states can be selected. Even if a greater number of operating states and, correspondingly, switching states for first and second switches are required in total above the normal and linked operating states, then the greater complexity in the module is more than compensated for by the considerably reduced amounts of effort for testing the front-end module. A reduced test time saves costs, in that the proposed front-end module is also more cost-effective than comparable known front-end modules with only normal operating states.

However, in a linked operating state, it is also possible to combine two paths and the operating modes associated with them such that normal operation via one of the two paths is still possible despite two paths being enabled in parallel. This means that the linked operating states can be used for normal operation without them being interfered with by the additionally enabled path. This reduces the number of required operating states, in which case all the paths can be operated reliably and without interference during this normal operation, as well.

For interference-free operation without excessive crosstalk between the two paths, it is possible to combine those paths which are associated with different sections of the front-end module. It is therefore advantageous to combine a path from the high-band section with a path from the low-band section. Furthermore, it may be advantageous, in addition to the section separation, to also combine those paths which are associated with different system architectures. One of the two linked operating states can accordingly be designed for a WCDMA system, and the other in contrast for a GSM system.

It is also advantageous if different frequencies in different frequency bands of the linked operating states cannot form intermodulation products which are in an interference range for reliable operation of the front-end module. For linked operating states with paths which are associated with the same system architecture, despite being associated with different sections, it is advantageous to combine a signal path for transmission signals and a received signal path.

### BRIEF DESCRIPTION OF THE DRAWINGS

The invention will be explained in more detail in the following text with reference to exemplary embodiments and the associated figures.

FIG. 1 shows the circuit diagram of a front-end module schematically on the basis of a circuit diagram;

FIG. 2 shows a mode table to show operating states that can be selected in the front-end module;

FIG. 3 schematically illustrates how a front-end module FEM can be connected, for example, to a network analyzer NA for testing;

FIGS. 4, 5 and 6 show mode tables in which operating states are listed for normal operating states, linked operating states and combinations of normal and linked operating states for a front-end module according to the invention; and

FIG. 7 shows a test arrangement according to the invention which allows parallel testing of paths which are enabled in parallel in linked operating states.

The following list of reference symbols can be used in conjunction with the drawings.

A Antenna connection

A′ Further antenna connection

DU Duplexer

FR Reception filter

HBTX Transmission filter HB

LBTX Transmission filter LB

NA Network analyzer

RX Received signal output

PA Transmission input

S1 Switch, first

S2 Switch, second

TA Connection NA

TS Test switch

S1 Switch, first

S2 Switch, second

TA Connection NA

S1′ Further first switch

### DETAILED DESCRIPTION OF ILLUSTRATIVE EMBODIMENTS

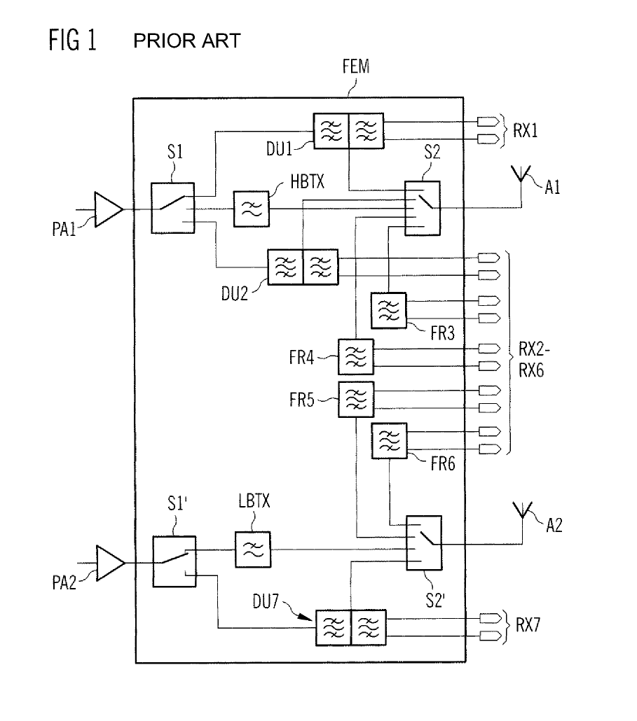

The exemplary embodiments are based on a front-end module FEM, as illustrated in FIG. 1, in which first switches S1, S1′ and second switches S2, S2′ are designed according to the invention. While a known front-end module as illustrated in FIG. 1 can switch only the operating states for normal operation as listed in the mode table in FIG. 2, three further linked operating states are additionally provided in a first exemplary embodiment, are intended for test operation of the front-end module, and are implemented in the form of appropriately configured switching states, which can be selected using the switch.

FIG. 4 shows the mode table with the linked operating states 10 to 13. Transmission operation in the GSM 850 reception path is combined with simultaneous operation in the WCDMA 2100 mobile radio system as the low-band operating mode in the additional operating state 10. The operating states which are connected here therefore have a different system architecture (GSM versus WCDMA) and section (low-band versus high-band).

In the further linked operating state 11, reception operation in the GSM 900 mobile radio system is combined with the WCDMA 1900 mobile radio system.

In the third additional or linked operating states with the operating state number 12, a WCDMA 900 system is combined with reception operation in the GSM 1800 mobile radio system.

The operating state 13 combines transmission operation in the low-band section for a GSM system with reception operation in the GSM 1900 system. Although two GSM mobile radio systems are combined here, it would therefore nevertheless differ with respect to the transmission/reception operating mode and with respect to the section (low-band/high-band).

The linked operating states 10 to 13 make it possible to carry out a test process for the front-end module and in the process to test the paths for eight of the normal operating states 1 to 8 in linked operating states without any concern about mutual interaction between the paths in the test mode. The path for the remaining ninth normal operating state is not linked to this exemplary embodiment, and is tested separately. Therefore, all that is still required to test the front-end module is to test four linked operating states and one normal operating state sequentially, in which case the test time required for this purpose is virtually halved in comparison to sequential testing of 9 normal operating states.

FIG. 5 shows a mode table which lists the operating states according to a further exemplary embodiment. The mode table contains a total of nine operating states, of which four are linked operating states. The linked operating states in this case consist only of those combinations of paths in which individual ones of the connected paths can also be used in normal operation without being influenced by the second path which is enabled in parallel. This is also once again subject to the constraint that only paths from different sections may be combined to form linked operating states.

Operating state number 1 is provided as the normal operating state for reception operation in the GSM 850 mobile radio system. Mode number 2 is provided as the normal operating state in reception operation for GSM 900. Operating state number 3 is a pure WCDMA 900 normal operating state, while operating state number 4 is intended and reserved for transmission operation in the low-band section of a GSM system. The mode (operating state) number 5 is a normal operating state for operation in the WCDMA 2100 system. In the linked operating state 6, the paths for a WCDMA 1900 system and for reception operation in GSM 850 are combined. At the same time, this mode, or this linked operating state, is used for normal operation of the front-end module in the WCDMA 1900 system. The linked and at the same time enabled GSM 850 received signal path does not interfere with normal operation in the WCDMA 1900 system.

In the linked operating state 7, reception operation in the GSM 1800 mobile radio system is combined with reception operation in the GSM 900 mobile radio system. At the same time, this linked operating state can be used for normal reception operation in the GSM 1800 system. In the further linked operating state 8, the method of reception in the GSM 1900 system is combined with the WCDMA 900 system. At the same time, in this linked operating state, the GSM 1900 reception operation can be used during normal operation of the front-end module. In the last linked operating state 9, transmission operation in the GSM high-band section is combined with transmission operation in the GSM low-band section. At the same time, the linked operating state 9 is used as the normal operating state for transmission operation in the GSM high-band section.

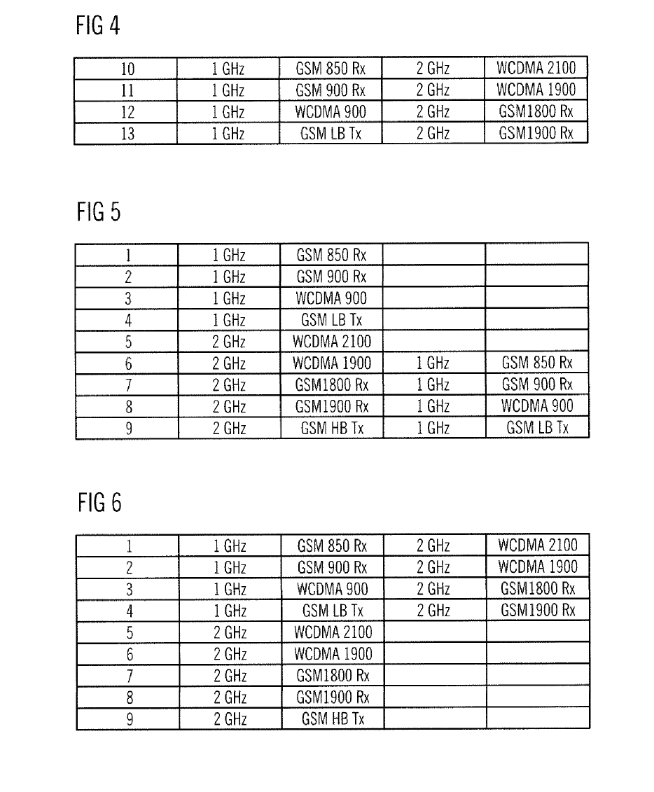

In a third exemplary embodiment, FIG. 6 uses a mode table to list nine operating states for a front-end module according to the invention, four of which are linked operating states and five are normal non-linked operating states. At the same time, one of the paths which is enabled in a linked operating state can in each case also be used during normal operation. In the exemplary embodiment, the received signal paths for GSM 850 operation in the first operating state (mode number 1) are combined with the WCDMA 2100 system. In operating state number 2, reception operation in the GSM 900 system is combined with the WCDMA 1900 system. In the linked operating state number 3, the WCDMA 900 system is combined with reception operation in the GSM 1800 system. The fourth and final linked operating state combines transmission operation in the GSM low-band section with reception operation in the GSM 1900 mobile radio system. The WCDMA 2100 system is carried out as the non-linked remaining normal mode in the operating state number 5, the WCDMA 1900 system in the operating state number 6, reception operation in the GSM 1800 system in the operating state number 7, reception operation in the GSM 1900 system in the operating state number 8, and transmission operation in the high-band section of the GSM system in the operating state number 9.

Furthermore, the linked operating states 1 to 4 can also be used as normal operating states for operation in the respective first-mentioned operating mode, which is in each case associated with the low-band section. Because of the association between the different sections and the suitable combination of frequencies, no intermodulation products or mutual interference occur here either, which could interfere with normal operation in the low-band section of the linked operating states.

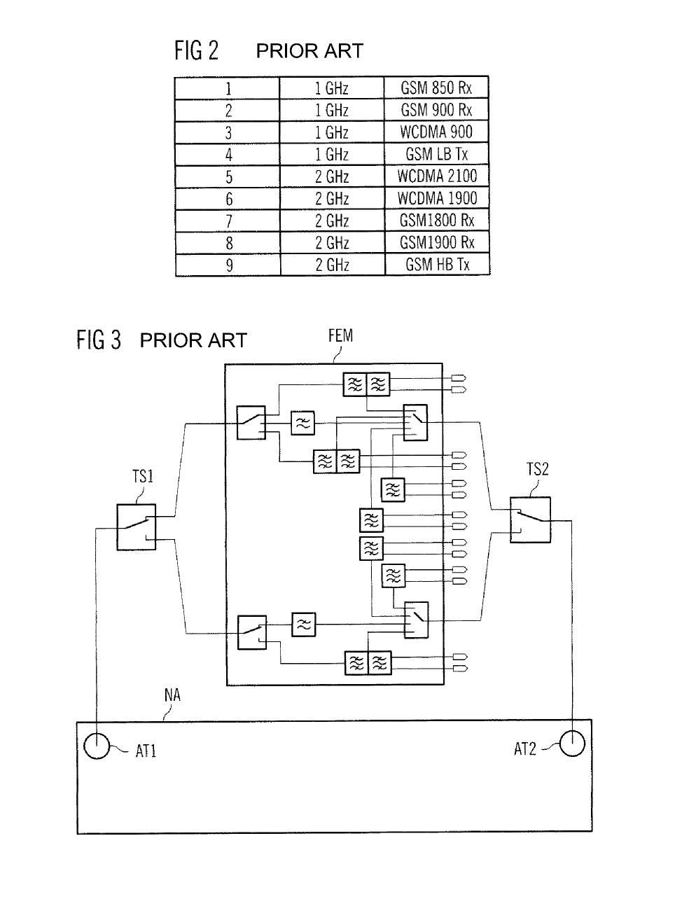

By way of example, a front-end module according to the invention can be tested connected as illustrated in FIG. 3, provided that the two test switches TS1 and TS2 allow, as an additional third switch position, parallel connection of the two paths to the first transmission input and further first transmission input, and/or to the second switch and the further second switch. This is the only way in which a linked operating state can be selected and can be measured in the network analyzer NA, which in each case combines one signal path from the first and second sections.

In order to measure a front-end module, this module is normally plugged into a measurement adapter which makes contact with the connections of the front-end module and provides a connection to corresponding connections of the network analyzer NA. The front-end module FEM can be held in the measurement adapter with the aid of spring contacts, which allow the front-end module to be plugged into the adapter, and unplugged from it, easily and quickly, therefore allowing a rapid change to the next front-end module.

In order to test an unlinked operating state or a linked operating state, a sequence of test signals is now generated alternately at one of the two connections AT1 and AT2 of the network analyzer NA, and the result is measured at the respective other connection. For the sake of clarity, the figure does not illustrate the connections of the received signal outputs RX, which must likewise be connected to the network analyzer NA in order to test the reception operating modes of the GSM system and of the WCDMA systems as well. Since the connection to the network analyzer NA is made only for test purposes, it is possible to connect a plurality of received signal outputs RX jointly in parallel with one of the test connections AT.

A test routine is now carried out in a first test operating state, for testing. When the test routine for this operating state has ended, a second operating state is selected, and a test routine is carried out again. The test process is carried out by repeating the test routines in the various operating states which comprise all the linked operating states, until all the paths have been tested.

The values measured in the individual test operating states are compared with the predetermined specifications for the front-end module, and the assessment “complies with the specification” or “does not comply with the specification” is appropriately allocated to the tested module. For the front-end modules which do not comply with the specification, it is possible to draw conclusions from the test result with regard to the reasons why they have not complied with the specification. This can be used to adapt possibly faulty production processes, and thus to reduce the fault rate. It is also possible to correct an allocated fault, which led to the specification not being complied to, by reworking or trimming of trimmable components, and in particular trimmable resonators or passive components on the front-end module, and thus to contribute to subsequent compliance with the specification.

At least all the linked operating states are used for testing in the test process. Remaining paths to be tested which are not enabled in a linked operating state are tested on the basis of the switch position of their normal operating state, in which only this path is enabled. The time required to carry out the test process is shortened considerably solely as a result of the reduced number of operating states to be tested. A further improvement can be achieved if paths such as these are enabled in parallel to form linked operating states, which require similar test times for carrying out the test routine. This results in the shortest possible overall test time.

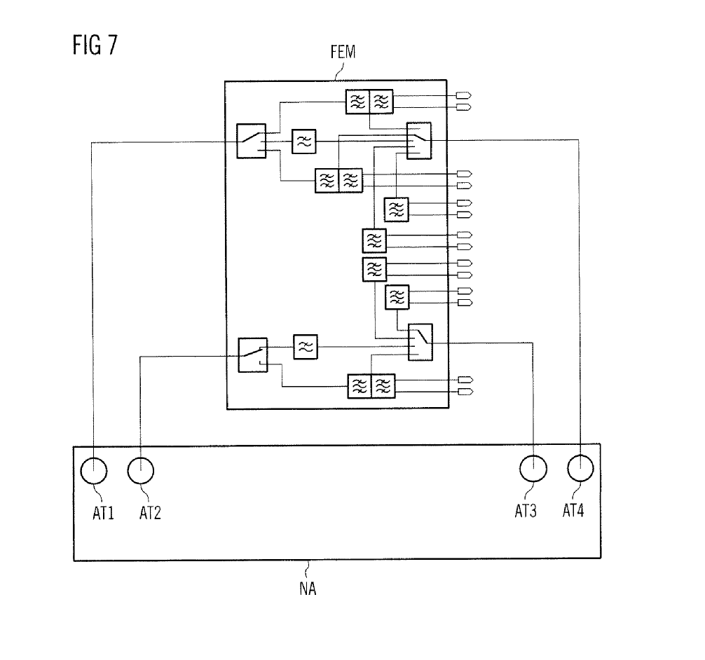

FIG. 7 shows a test arrangement according to an embodiment of the invention which allows parallel testing of paths which are enabled in parallel in linked operating states. The figure once again shows the front-end module FEM known from the prior art as shown in FIG. 1. Here, the two transmission signal inputs, which respectively open in the first or in the further first switch, are connected in parallel to corresponding connections AT1, AT2 of the network analyzer NA. The two antenna connections, to be precise the second or further second switches which are connected to the respective antenna connection, are connected to further connections AT3, AT4 of the network analyzer NA.

The connections of the received signal inputs RX to corresponding connections of the network analyzer are not shown, in order to prevent the figure from being too complex and unclear. Correspondingly, all connections, which can be inputs or outputs, are connected during the measurement to corresponding connections AT of the network analyzer NA. During testing, the corresponding connections of the network analyzer are enabled in the course of the test routine. In parallel with this, the respective operating state which is intended to be tested is selected on the switches, which may be in the form of a single switching element, on the basis of the mode control table. In this case, the mode table is physically integrated in the decoder of the switch or switches. The decoder may be CMOS-based and may be provided in a silicon chip. However, it is also possible to provide the decoder, and therefore the mode control table which has the additional linked operating states which implement the invention, in the same semiconductor component as the switch or switches.

The invention is not restricted to a front-end module which has nine normal operating states, as described.

To the same extent, the invention cannot be restricted to linked operating states corresponding to the described exemplary embodiments. In fact, the invention can be applied broadly to all front-end modules with any desired number of transmission, reception and combined transmission-reception paths, which are accessible in any desired number and combination with the aid of the invention using the simplified test process. In all cases, the additional operating states are provided physically at the front-end module or the switch or controller located thereon. In any case, a simplified and shortened test process which saves not only time but also effort and therefore costs is advantageous.

What is claimed is:

1. A front-end module for a wireless communication system, the front-end module comprising:
a transmission input for transmission signals, wherein the front-end module is designed for operation in a plurality of frequency bands;
an antenna connection;
at least two signal paths that are each associated with one frequency band and each connect the transmission input to the antenna connection;
a set of control lines; and
a first switch that connects the transmission input selectively to one of the signal paths corresponding to a selected operating state, wherein the first switch is designed such that operating states for normal operation of the front-end module and in addition at least one linked operating state for a test mode can be selected via the set of control lines.

2. The front-end module as claimed in claim 1, wherein, in the at least one linked operating state, a common connection is provided for a plurality of signal paths to the transmission input.

3. The front-end module as claimed in claim 1, further comprising a second switch that connects the antenna connection to one of the signal paths in accordance with a selected operating state, wherein operating states for normal operation of the front-end module and additionally at least one linked operating state for a test mode can also be selected in the second switch, wherein, in the at least one linked operating state, a common connection is provided for a plurality of signal paths to the antenna connection.

4. The front-end module as claimed in claim 3, wherein the first and second switches are switched with a single set of common control lines to different combined operating states, wherein both selective enabling of individual signal paths and parallel enabling of the plurality of signal paths are provided as combined operating states in a linked operating state.

5. The front-end module as claimed in claim 3, wherein the first and second switches are provided in a single semiconductor component.

6. The front-end module as claimed in claim 1, further comprising further signal paths, a further first switch and a further transmission input, wherein the further first switch is connected to the further transmission input and to each individual one of the further signal paths.

7. The front-end module as claimed in claim 6, further comprising a further second switch and a further antenna connection, wherein the further second switch connects the further antenna connection selectively to one or more of the further signal paths.

8. The front-end module as claimed in claim 1, further comprising a single transmission filter provided in each signal path.

9. The front-end module as claimed in claim 1, further comprising a duplexer provided in each signal path.

10. The front-end module as claimed in claim 1, further comprising:
a plurality of received signal paths and a reception output to each reception path, which reception output is in each case connected thereto;
a reception filter or a duplexer arranged in each received signal path,
wherein each reception path connects a reception output to a duplexer or to one of a plurality of second switches,
wherein the second switches provide as operating states not only selective connection of individual signal paths or received signal paths in each case to the antenna connection but also a common connection of a plurality of signal paths or received signal paths to the antenna connection.

11. A method for testing a front-end module that comprises the front-end module comprising a transmission input, an antenna connection, at least two signal paths that are each associated with one frequency band and each connect the transmission input to the antenna connection, a set of control lines, and a first switch that connects the transmission input selectively to one of the signal paths corresponding to a selected operating state, wherein the first switch is designed such that operating states for normal operation of the front-end module and in addition at least one linked operating state for a test mode can be selected via the set of control lines, the method comprising:
connecting the transmission input and the antenna connection to corresponding inputs and outputs of a network analyzer, wherein the first switch or a second switch are switched to a first combined operating state;
carrying out a first test routine in which test signals are applied via the network analyzer to the transmission input and test output signals are measured at the antenna connection;
causing the first or second switches to be switched to at least one second operating state; and
carrying out a second test routine in the second operating state,
wherein one of the tested operating states is a linked operating state, in which a plurality of signal paths are enabled at the same time for the test signals.

12. The method as claimed in claim 11, wherein two paths are enabled in parallel in the linked operating state and are associated with different mid-frequencies which are arranged in different decades.

13. The method as claimed in claim 12, wherein two paths are enabled in parallel in the linked operating state and are associated with different mobile radio systems and comprise a WCDMA system in addition to a TDMA system.

14. The method as claimed in claim 12, wherein one signal path and one received signal path are enabled in parallel in the linked operating state.

15. The method as claimed in claim 12, wherein a sufficient number of test routines are carried out in a corresponding number of operating states that all signal paths and all received signal paths are each enabled at least once.

16. The method as claimed in claim 15, wherein the number of test routines carried out is less than a number of possible operating states in normal operation, and is less than a total number of all the signal paths and received signal paths in the front-end module.
